(19) United States
(12) Patent Application Publication
(10) Pub. No.: US 2012/0039597 A1
(43) Pub. Date: Feb. 16, 2012

(54) FIBER OPTIC CROSS CONNECT WITH NON-INTRUSIVE MONITORING AND CIRCUIT TRACER

(76) Inventors: Benny Gaber, Haifa (IL); Roni Herzel, Ramat Hasharon (IL)

(21) Appl. No.: 13/202,581

(22) PCT Filed: Feb. 25, 2010
(86) PCT No.: PCT/US10/25293

§ 371 Date: Aug. 22, 2011

Related U.S. Application Data
(60) Provisional application No. 61/155,553, filed on Feb. 26, 2009.

(51) Int. Cl. H04B 10/08

(52) U.S. Cl. 398/9

(57) ABSTRACT

A non-intrusive monitoring optical connection between two fiber optic lines including a sending fiber optic end that emits light to a first lens that collimates the light to a larger diameter parallel beam of light that enters a tunnel, a second lens that focuses the light from the tunnel to an end of a receiving fiber optic line, a mirror disposed in the tunnel between the first and second lenses, which reflects and diverts part of the parallel beam of light to a diverting tunnel, and a second diverting mirror, disposed at a non-zero angle to a longitudinal axis of the diverting tunnel, which directs the beam from the diverting tunnel into a second diverting tunnel wherein it is collimated by a third lens, disposed in the second diverting tunnel, to an end of a monitoring fiber optic line.

### FIELD OF THE INVENTION

The present invention relates generally to non-intrusive monitoring signals between two lines of fiber optic communication utilizing two opposed collimators wherein part of the collimated light may be monitored without interrupting the service during transmission of optical information data.

### BACKGROUND OF THE INVENTION

Fiber optics distribution frames, patch panels and termination devices today do not offer cost-effective, non-intrusive, bi-directional (transmit/receive) monitoring capabilities. Currently, an active line is monitored by disconnecting it and attaching a monitor line to its end. Another solution utilizes a splitter which requires expensive tooling and extra spacing with an additional box.

### SUMMARY OF THE INVENTION

In accordance with an embodiment of the present invention, a non-intrusive monitoring optical connection is provided between two fiber optic lines wherein the emitted light from a sending fiber optic end is collimated to a larger diameter parallel beam of light by a first lens, wherein the parallel larger diameter beam of light goes in a tunnel wherein a second lens focuses the light to the end of a receiving fiber optic line.

A mirror disposed in the tunnel, between the two lenses, preferably with at 45° relative to the lens axis, and facing the emitting fiber optic line, reflects and diverts part of the parallel beam of light to a diverting tunnel. A periscope-like second diverting mirror, preferably at 45° relative to the diverting tunnel axis directs the reflected beam into a second diverting tunnel wherein it is collimated by a third lens, disposed in the second diverting tunnel, to the end of a monitoring fiber optic line.

In accordance with another embodiment of the present invention, a non-intrusive monitoring optical connection is provided between two fiber optic lines, wherein the emitted light from a sending fiber optic end is collimated to a larger diameter parallel beam of light by a first lens, wherein the parallel larger diameter beam of light goes in a tunnel wherein a second lens focuses the light to the end of the receiving fiber optic line.

A rotatable mirror disposed in that tunnel, between the two lenses, preferably at 45° relative to the lens axis, and facing the emitting fiber optic line, is rotatable by a lever to face the emitting fiber optic line. The mirror reflects and diverts part of the parallel beam of light to a diverting tunnel. A periscope-like second diverting mirror, preferably at 45° relative to the diverting tunnel axis directs the reflected beam into a second diverting tunnel wherein it is collimated by a third lens, disposed in the second diverting tunnel, to the end of a monitoring fiber optic line.

In accordance with yet another embodiment of the present invention, a non-intrusive monitoring optical connection is provided between two fiber optic lines, wherein the emitted light from a sending fiber optic end is collimated to a larger diameter parallel beam of light by a first lens, wherein the parallel larger diameter beam of light goes in a tunnel wherein a second lens focuses the light to the end of the receiving fiber optic line.

Two side-by-side mirrors disposed in the tunnel, between the two lenses, preferably each at 45° relative to the lens axis and each facing one of the emitting fiber optic lines, reflect and divert part of the parallel beam of light to a diverting tunnel. A periscope-like second diverting mirror, preferably at 45° relative to the diverting tunnel axis directs the reflected beam into a second diverting tunnel wherein it is collimated by a third lens, disposed in the second diverting tunnel, to the end of a monitoring fiber optic line.

In yet another embodiment of the present invention accordance, a non-intrusive monitoring optical connection is provided between two fiber optic lines wherein the emitted light from a sending fiber optic end is collimated to a larger diameter parallel beam of light by a first lens, wherein the parallel larger diameter beam of light goes in a tunnel wherein a second lens focuses the light to the end of the receiving fiber optic line.

A semi-reflecting mirror is disposed in the tunnel, between the two lenses, preferably at 45° relative to the lens axis, reflects and diverts part of the coming light from one side of the semi-reflecting mirror to a diverting tunnel. A periscope-like second diverting mirror, preferably at 45° relative to the diverting tunnel axis directs the reflected beam into a second diverting tunnel wherein it is collimated by a third lens, disposed in the second diverting tunnel, to the end of a monitoring fiber optic line. If the emitted light comes from the other side of the semi-reflecting mirror, then part of the light is reflected from the other side of the semi-reflecting mirror face onto a mirror disposed below the semi-reflecting mirror whose reflecting face is parallel to the lens axis, which reflects this light through the semi-reflecting mirror to the above diverting tunnel.

In accordance with another embodiment of the present invention, a non-intrusive monitoring optical connection is provided between two fiber optic lines wherein the emitted light from a sending fiber optic end is collimated to a larger diameter parallel beam of light by a first lens were that parallel larger diameter beam of light goes in a tunnel wherein a second lens focuses the light to the end of the receiving fiber optic line.

A double-faced mirror with two reflecting sides is disposed in the tunnel, between the two lenses, preferably each at 45° relative to the lens axis, and reflects light coming from any side from any of the fiber optic lines by the relevant side of the double faced mirror, to the diverting tunnel according to the fiber optic that serves as the transmitter. A periscope-like second diverting mirror, preferably at 45° relative to the diverting tunnel axis directs the reflected beam into a second diverting tunnel wherein it is collimated by a third lens, disposed in the second diverting tunnel, to the end of a monitoring fiber optic line.

In yet another embodiment of the present invention, a non-intrusive monitoring optical connection is provided between two fiber optic lines wherein the emitted light from a sending fiber optic end is collimated to a larger diameter parallel beam of light by a first lens. The parallel larger diameter beam of light goes in a tunnel wherein a second lens focuses the light to the end of the receiving fiber optic line. A reflecting device according to any embodiment of the invention reflects the light in the diverting tunnel, wherein it is collimated by a fourth lens to the end of a monitoring fiber optic line.

In yet another embodiment of the present invention (wherein the system can be built in accordance with any or all of the above configurations), the monitoring port, when not connected to a monitoring fiber optic line, is covered by a transparent cap which is illuminated by the reflecting beam from the light emitted by the active fiber optic line, thus indicating visually whether the service and or line is active and operative.

In yet another embodiment of the present invention (wherein the system can be built in accordance with any or all of the above configurations), the monitoring port, when not connected to a monitoring fiber optic line, is covered by a transparent cap whose color changes in accordance with illumination by the reflecting beam from the laser light emitted by the active fiber optic line thus indicating visually whether the service and or line is active and operative.

### BRIEF DESCRIPTION OF THE DRAWINGS

The disclosed technique will be understood and appreciated more fully from the following detailed description taken in conjunction with the drawings in which:

FIG. 1-1 is a simplified sectional view illustration of the system including an optical connection between one in-line fiber optic to an out-line fiber, wherein the light is collimated and focused again by two opposed lenses and a mirror diverts part of the light to another mirror reflecting the light, via another lens, to a monitoring port, in accordance with an embodiment of the invention.

FIG. 1-2 is a simplified sectional view illustration of the system of FIG. 1-1.

FIG. 2-1 is a simplified sectional view illustration of the system including an optical connection between one in-line fiber optic to an out-line fiber, wherein the light is collimated and focused again by two opposed lenses and a rotatable mirror diverts part of the light coming from left fiber optic line to another mirror reflecting the light, via another lens, to a monitoring port, in accordance with an embodiment of the invention.

FIG. 2-2 is a simplified sectional view illustration of the system of FIG. 2-1 wherein the rotatable lens reflects light coming from right fiber optic line to another mirror reflecting the light, via another lens, to a monitoring port.

FIG. 3-1 is a simplified sectional view illustration of the system including an optical connection between one in-line fiber optic to an out-line fiber wherein the light is collimated and focused again by two opposed lenses and side-by-side mirrors divert part of the light, according to the emitting light side, to another mirror reflecting the light, via another lens, to a monitoring port.

FIG. 3-2 is a schematic cut from top view illustration of the system of FIG. 3-1.

FIG. 3-3 is a simplified sectional view illustration of the system of FIG. 3-1.

FIG. 4 is a simplified sectional view illustration of the system including an optical connection between one in-line fiber optic to an out-line fiber wherein the light is collimated and focused again by two opposed lenses and a semi-reflecting mirror and parallel mirrors divert part of the light coming from either the left fiber or right optic line to another mirror reflecting the light, via another lens, to a monitoring port.

FIG. 5 is a simplified sectional view illustration of the system including an optical connection between one in-line fiber optic to an out-line fiber wherein the light is collimated and focused again by two opposed lenses and a double faced mirror with two reflecting sides diverts part of the light coming from either the left fiber or right optic line to another mirror reflecting the light, via another lens, to a monitoring port.

FIG. 6 is a simplified sectional view illustration of the system including an optical connection between one in-line fiber optic to an out-line fiber wherein the light is collimated and focused again by two opposed lenses and a mirror diverts part of the light coming from either the left fiber or right optic line wherein another lens focuses the light to a monitoring port.

FIG. 7-1 is a simplified sectional view illustration of the system with a cap on the monitoring port.

FIG. 7-2 is an enlarged view of FIG. 7-1 in the monitoring area.

### DETAILED DESCRIPTION OF THE EMBODIMENT

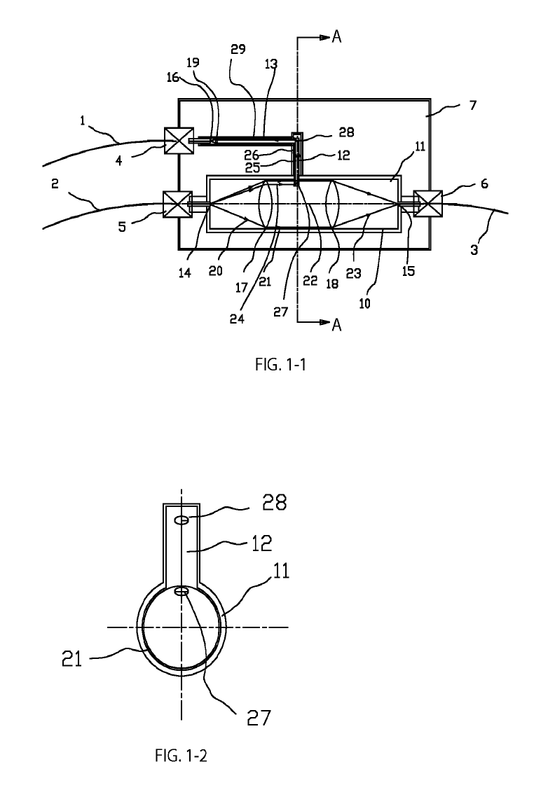

Reference is now made to FIG. 1-1 in which an optical connection between emitting fiber optic line 2 and receiving fiber optic line 3 with a non-intrusive fiber optic line 1 may measure operational performance. The emitting fiber optic line 2 is connected to the connection box 7 via a mechanical connection 5 wherein the tip 14 of emitting fiber optic line 2 goes in a light cone 20 to be collimated by lens 17 to a parallel beam 21 and that parallel beam 21 is focused to the tip 15 of the receiving fiber optic line 3 that is mechanically connected to the connection box 7 by a connection 6. Mirror 27 reflects part of the parallel beam 21 and diverts the reflection 12 onto a mirror 28 in tunnel 26 wherein it is reflected and diverted to a lens 19 disposed in tunnel 13 wherein lens 19 focuses the parallel beam 21 onto the tip end 16 of the monitoring fiber optic line 1 that is connected to the connection box by a mechanical connector 4.

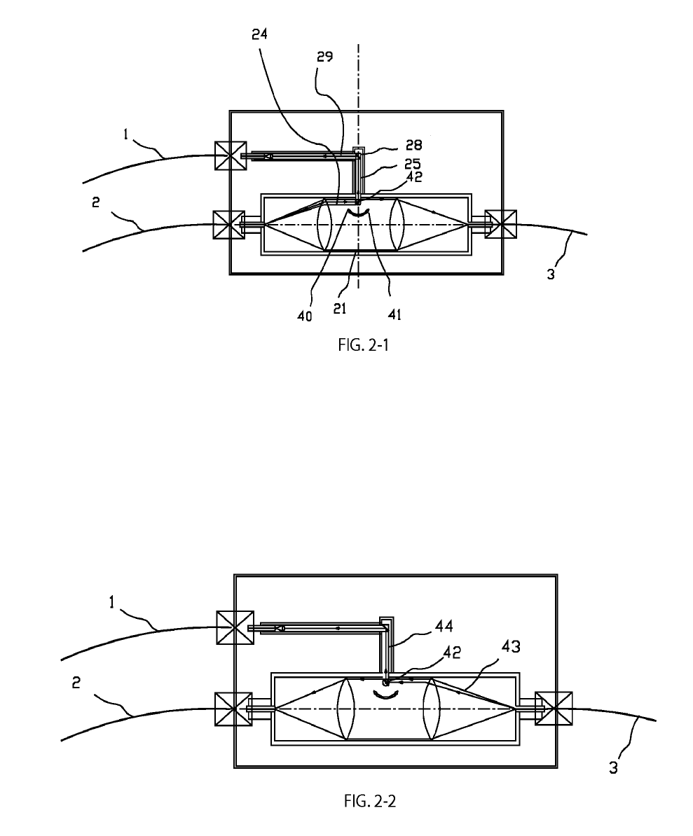

Reference is now made to FIG. 1-2 which is a sectional view of FIG. 1-1 along arrows 8 and 9 in FIG. 1-1, wherein mirror 27 covers only part of the parallel beam 21 and wherein the second mirror 28 is disposed in tunnel 12.

Reference is now made to FIG. 2-1 in which an optical connection between emitting fiber optic line 2 and receiving fiber optic line 3 with a non-intrusive fiber optic line 1 may measure operational performance as in FIG.-1. After the light emitted from fiber optic line 2 is collimated it is reflected by a rotatable mirror 42 into beam 25 wherein it is diverted by mirror 28 to be focused again to the monitoring line 1. The rotatable mirror 42 may rotate in the direction indicated by arrows 40 and 41.

Reference is now made to FIG. 2-2 which is the same as FIG. 2-1 but with the rotatable mirror 42 rotated to the other emitting fiber 3 and the reflecting beam 44 reflected from the new position of the rotatable mirror 42.

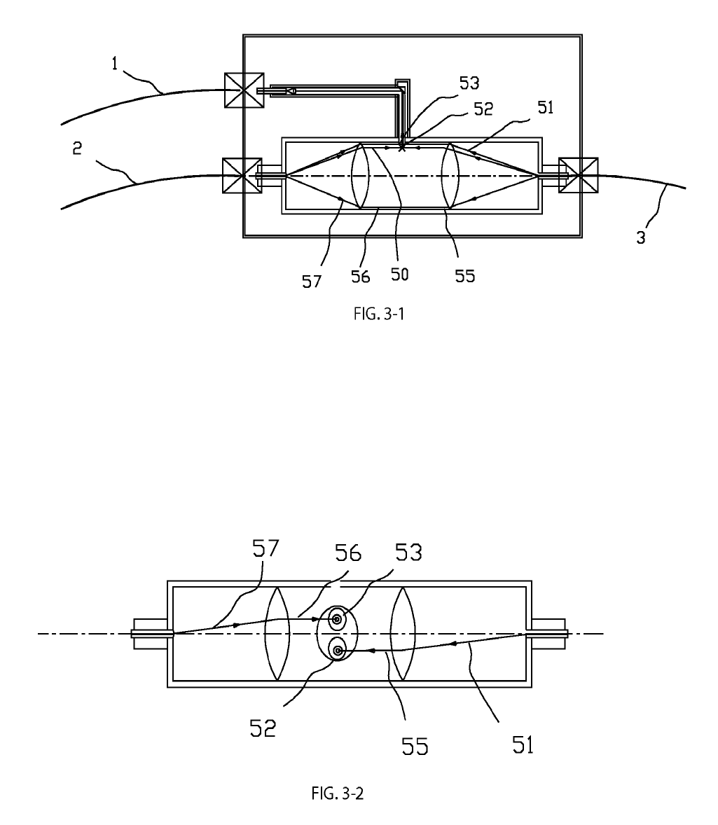

Reference is now made to FIG. 3-1 in which an optical connection between emitting fiber optic line 2 and receiving fiber optic line 3 or between emitting fiber optic line 3 and receiving fiber optic line 2 with a monitoring non-intrusive fiber optic line 1 may measure operational performance as in FIG.-1 wherein after the light emitted from fiber optic line 2 goes in its natural dispersed cone 57 and is collimated to a parallel beam 56 wherein part of that parallel beam 56 is reflected by side-by-side mirror face 52. Alternatively, light emitted from fiber optic line 3 goes in its natural dispersed cone 51 and is collimated to a parallel beam 55 wherein part of that parallel beam 55 is reflected by side-by-side mirrors face 53 and then, as in FIG.-1-1, the reflected beam is reflected and focused on the monitoring fiber optic line 1.

FIG. 3-2 which illustrates the side-by-side mirror faces 52 and 53. FIG. 3-3 illustrates the side-by-side mirror faces 52 and 53.

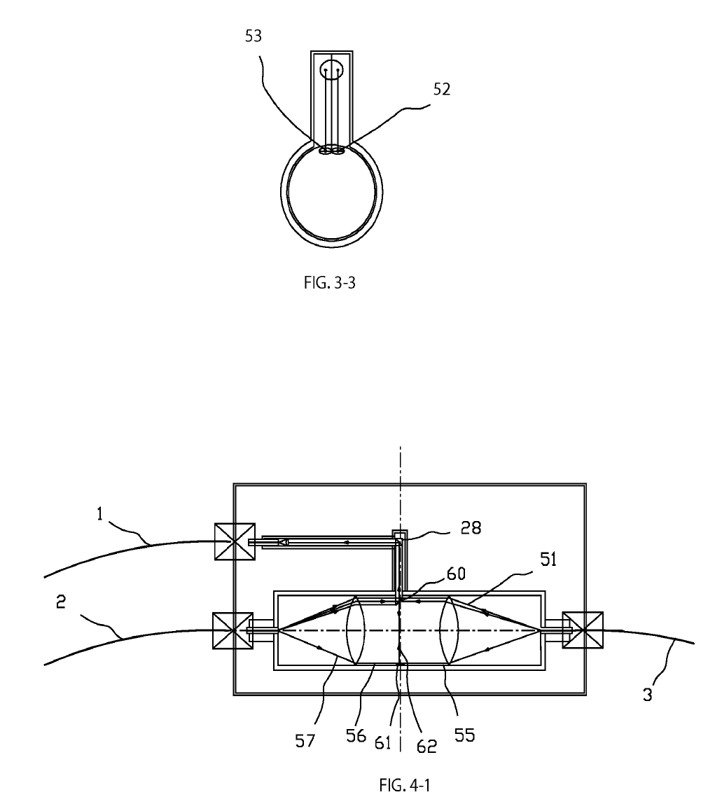

Reference is now made to FIG. 4-1, which is a simplified sectional view illustration of the system in FIG. 1-1 wherein a semi-reflecting mirror 60 reflects part of the collimated light 56 from line 2 to the reflecting mirror 28. Semi-reflecting mirror 60 reflects part of the collimated light 55 from line 3 along line 62 to a parallel mirror 61 wherein it reflects back through the semi-reflecting mirror 60 to the reflecting mirror 28.

FIG. 4-2 illustrates the system with a semi-reflecting mirror.

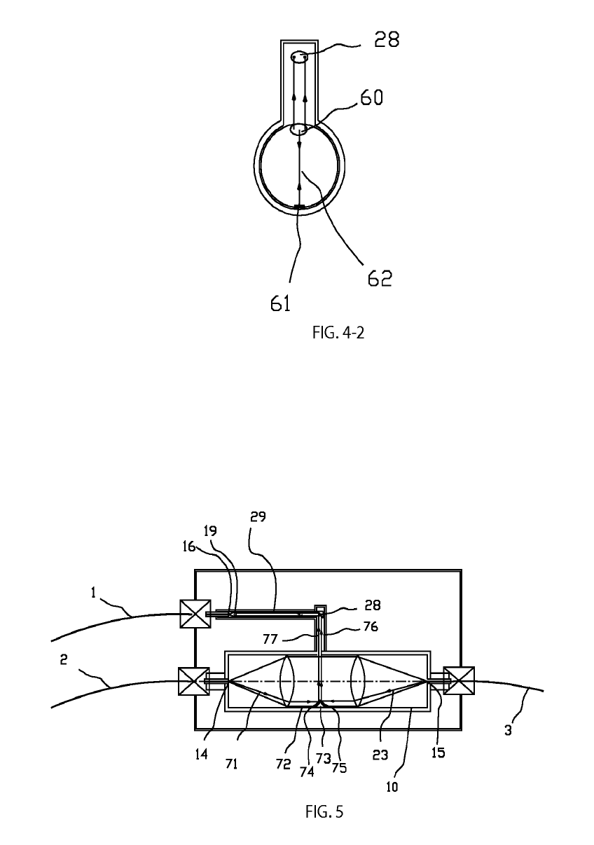

Reference is now made to FIG. 5, in which an optical connection between fiber optic line 2 and fiber optic line 3 with a non-intrusive fiber optic line 1 may measure operational performance. If the emitting fiber optic line is line 2, then the light leaves the tip 14 of line 2 and goes in its natural dispersed cone 71 and is collimated to a parallel beam 72. Part of that parallel beam 72 is reflected by a double faced mirror 73 at left face 74, wherein the reflected beam 77 is reflected by mirror 28 to be focused by lens 19 to the tip 16 of monitoring line 1.

When the emitting fiber optic line is line 3, then the light leaves the tip 15 of line 3 and goes in its natural dispersed cone 23 and is collimated to a parallel beam 72. Part of parallel beam 72 is reflected by double faced mirror 73 at right face 75, wherein the reflected beam 76 is reflected by mirror 28 to be focused by lens 19 the tip 16 of monitoring line 1.

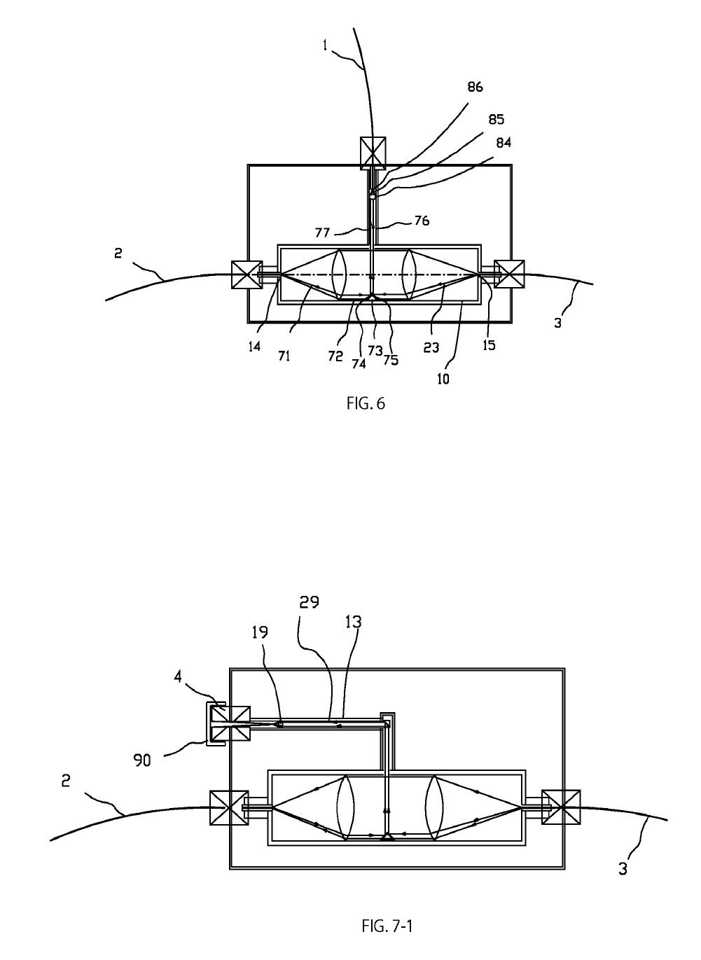

Reference is now made to FIG. 6, in which an optical connection between fiber optic line 2 and fiber optic line 3 with a non-intrusive fiber optic line 1 may measure operational performance. If the emitting fiber optic line is line 2, then the light leaves the tip 14 of line 2 and goes in its natural dispersed cone 71 and is collimated to a parallel beam 72 wherein part of parallel beam 72 is reflected by a double faced mirror 73 at left face 74, wherein the reflected beam 77 is focused by a fourth lens 84 in a cone 85 onto tip 86 of monitoring line 1.

When the emitting fiber optic line is line 3, then the light leaves the tip 15 of line 3 and goes in its natural dispersed cone 23 and is collimated to a parallel beam 72. Part of parallel beam 72 is reflected by double faced mirror 73 at right face 75, wherein the reflected beam 76 is focused by a fourth lens 84 in a cone 85 onto tip 86 of monitoring line 1.

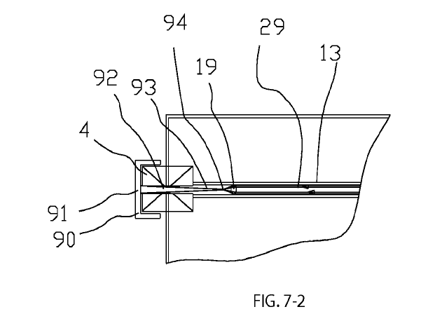

Reference is now made to FIG. 7-1. The system has a cap on the monitoring port. The reflected beam 29 goes in tunnel 13 and is focused by the forth lens 19 and illuminates the cap 90 on the monitoring port 4.

Reference is now made to FIG. 7-2, which is an enlarged view of FIG. 7-1 in the monitoring area. The reflected light 29 goes in tunnel 13 wherein it is focused by lens 19 to point 94. Since in this instance the monitoring port is covered by a cap 91, the light focused in point 94 goes in its natural dispersed angle 93 in tunnel 92 wherein it illuminates the cap 90 on area 91.

what is claimed is:

1. A non-intrusive monitoring optical connection between two fiber optic lines comprising:
a sending fiber optic end that emits light to a first lens that collimates the light to a larger diameter parallel beam of light that enters a tunnel;
a second lens that focuses the light from the tunnel to an end of a receiving fiber optic line;
a mirror disposed in said tunnel between said first and second lenses, which reflects and diverts part of said parallel beam of light to a diverting tunnel; and
a second diverting mirror, disposed at a non-zero angle to a longitudinal axis of said diverting tunnel, which directs the beam from the diverting tunnel into a second diverting tunnel wherein it is collimated by a third lens, disposed in the second diverting tunnel, to an end of a monitoring fiber optic line.

2. The non-intrusive monitoring optical connection according to claim 1, wherein said mirror disposed in said tunnel between said first and second lenses is rotatable.

3. The non-intrusive monitoring optical connection according to claim 1, wherein said mirror disposed in said tunnel between said first and second lenses comprises side-by-side mirrors.

4. The non-intrusive monitoring optical connection according to claim 1, wherein said mirror disposed in said tunnel between said first and second lenses comprises a semi-reflecting mirror.

5. The non-intrusive monitoring optical connection according to claim 1, wherein said mirror disposed in said tunnel between said first and second lenses comprises a double faced mirror.

6. The non-intrusive monitoring optical connection according to claim 1, further comprising a fourth lens that focuses light from said diverting tunnel to the end of said monitoring fiber optic line.

7. The non-intrusive monitoring optical connection according to claim 1, further comprising a transparent cap illuminated by said beam.

8. The non-intrusive monitoring optical connection according to claim 7, wherein said cap changes color when illuminated by said beam.
